(19) United States
(12) Patent Application Publication
(10) Pub. No.: US 2024/0420575 A1
(43) Pub. Date: Dec. 19, 2024

(54) Method of Operating Radio Frequency Identification (RFID) Devices on a Vehicle

(71) Applicant: The Boeing Company, Arlington, VA (US)

(72) Inventors: Richard John Loftis, Charleston, SC (US); David Richard Bowman, Charleston, SC (US); Cedar Frost, Marysville, WA (US)

(21) Appl. No.: 18/334,710

(22) Filed: Jun. 14, 2023

(51) Int. Cl. G08G 5/00

(52) U.S. Cl. CPC G08G 5/0004; G08G 5/0052

(57) ABSTRACT

Methods of operating radio frequency identification (RFID) devices on a vehicle. The methods include determining a geographic location of the vehicle. Based on the geographic location of the vehicle, determining an operational requirement for the RFID devices. After determining the operational requirement, operating the RFID devices according to the operational requirement. The methods provide for operating the RFID devices within compliance for the operational requirements that are required in the different geographic locations where the vehicle travels.

### TECHNOLOGICAL FIELD

The present disclosure relates generally to the field of operating devices that are located on a vehicle and, more specifically, to a method of operating the RFID devices within compliance when used on a vehicle that travels to different geographic locations.

### BACKGROUND

Vehicles such as but not limited to aircraft, ships, trains, and buses travel between different geographic locations. Examples include but are not limited to an aircraft that travels between different countries, a train that travels between different states, and a bus that travels between different cities. The different geographic locations have different regulations. This can include regulations on operating equipment that is located on the vehicle. The devices need to be adjusted as necessary to ensure compliance with the requirements of the current geographic location where the vehicle is located.

One type of equipment located on vehicles is Radio Frequency Identification devices (RFID devices). RFID devices are used for various functions, including but not limited to tracking cargo and monitoring the position of doors and compartments. Different countries have different operational requirements for the use of RFID devices. In one example, the UHF allocations for the different countries are governed by the International Organization for Standardization (ISO). Different countries are allocated different frequency ranges within a range of between 860 to 960 MHz. Example include the United States operating within 902-928 MHz, France operating within 865.6-867.6 MHz, and China operating within 920.5-924.5 MHz.

It is difficult to maintain compliance for RFID devices on a vehicle. An RFID device configured for use in a first country may require adjustment prior to use in a different country. There is a need for maintaining RFID devices in compliance when used on a vehicle that travels between different geographic locations.

### SUMMARY

One aspect is directed to a method of operating radio frequency identification (RFID) devices on a vehicle. The method comprises: determining a geographic location of the vehicle; based on the geographic location of the vehicle, determining an operational requirement for the RFID devices; and operating the RFID devices according to the operational requirement.

In another aspect, the method further comprises adjusting a setting on the RFID devices resulting in the RFID devices operating according to the operational requirement.

In another aspect, the method further comprises determining the geographic location of the vehicle upon arrival of the vehicle at a destination.

In another aspect, determining the geographic location of the vehicle comprises determining latitude and longitude of the vehicle and determining a country code corresponding to the latitude and longitude.

In another aspect, the method further comprises determining a current frequency setting for the RFID devices, determining that the frequency setting for the RFID devices is outside of a frequency range, and adjusting the RFID devices to operate within the frequency range.

In another aspects, determining the operational requirement for the RFID devices comprises determining a power level of the RFID devices.

In another aspect, the method further comprises determining the geographic location and the operational requirement from one or more sources that are located on the vehicle.

In another aspect, determining the operation requirement comprises determining a UHF spectrum regulatory operational requirement for operating the RFID devices within a country where the vehicle is located.

One aspect is directed to a method of operating radio frequency identification (RFID) devices on a vehicle. The method comprises: determining a geographic location of the vehicle; determining a country code that corresponds to the geographic location; determining a frequency range of operation of the RFID devices that corresponds to the country code; and operating the RFID devices within the frequency range while the vehicle is at the geographic location.

In another aspect, the method further comprises polling an onboard computing system that is on the vehicle and determining one or more of the geographic location, the country code, and the frequency range.

In another aspect, the method further comprises determining that an event has occurred with the vehicle and determining the geographic location after the occurrence of the event.

In another aspect, determining the country code comprises determining an alpha-3 country code that corresponds to the geographic location.

In another aspect, the method further comprises determining a current frequency for the RFID devices, determining whether the current frequency is within the frequency range, adjusting a setting of the RFID devices in which the current frequency is outside of the frequency range; and operating the RFID devices within the frequency range.

In another aspect, determining the frequency range of operation of the RFID devices that corresponds to the country code comprises determining a UHF spectrum regulatory operational requirement for operating the RFID devices within a country where the vehicle is located.

One aspect is directed to a computing device configured to operate RFID devices. The computing device comprises memory circuitry that stores program instructions and processing circuitry. The processing circuitry is configured to execute the program instructions to cause the computing device to: determine a geographic location of the vehicle; determine a code that corresponds to the geographic location; determine a frequency range of operation for the RFID devices that corresponds to the code; and operate the RFID devices within the frequency range.

In another aspect, the processing circuitry is configured to configure one or more onboard systems and obtain the geographic location and the code.

In another aspect, the code is a country code that corresponds to a country where the vehicle is located.

In another aspect, the processing circuitry is further configured to transmit commands to adjust an operational feature of the RFID devices to operate within the frequency range.

In another aspect, the processing circuitry is configured to determine that one or more of the RFID devices are operating within the frequency range and to prevent adjustment of the one or more RFID devices.

In another aspect, the code is a city code that corresponds to a city where the vehicle is located.

The features, functions and advantages that have been discussed can be achieved independently in various aspects or may be combined in yet other aspects, further details of which can be seen with reference to the following description and the drawings.

### BRIEF DESCRIPTION OF THE DRAWINGS

FIG. 1 is a schematic diagram of a vehicle equipped with a computing device and an RFID system.

FIG. 2 is schematic diagram of a computing device connected to an RFID system.

FIG. 3 is a flowchart diagram of a method of operating a radio frequency identification (RFID) device on a vehicle.

FIG. 4 is a schematic diagram of a computing device communicatively connected to a navigation system and an RFID system.

FIG. 5 is a schematic diagram of the operation of a computing device to operate an RFID system in compliance with an operational requirement.

FIG. 6 is a flowchart diagram of a method of operating RFID devices on a vehicle.

### DETAILED DESCRIPTION

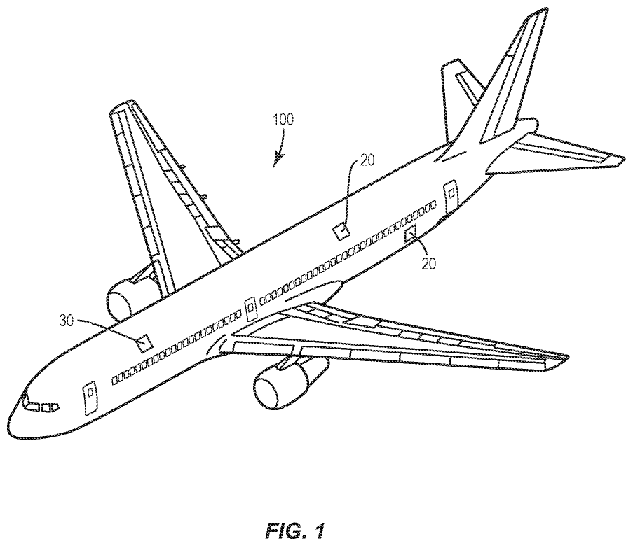

FIG. 1 illustrates an example of a vehicle 100 that travels to different geographic locations. A wide variety of vehicle 100 are applicable for use with the disclosed aspects. In this example, the vehicle 100 is an aircraft configured to fly routes of a variety of different geographic locations. The vehicle 100 can be equipped to transport passengers and/or cargo. The vehicle 100 is equipped with an Radio Frequency Identification (RFID) system 20 that provides for passive reading of identifying information. RFID system 20 can be used for a variety of different functions. Examples include but are not limited to monitoring luggage or cargo, monitoring life vests or other safety devices, and monitoring the orientation components such as overhead compartment doors and monument doors. A computing device 30 is configured to control the operation of the RFID system 20 to ensure compliance with the geographic-dependent operating parameters.

The RFID system 20 operates in accordance with the requirements of the geographic location where the vehicle 100 is located. The size of the geographic location can vary with examples including but not limited to a country (e.g., Germany), a state (e.g., North Carolina, USA), a region (e.g., Europe), and a city (Paris). The operational requirements can vary. In some examples, an operational requirement includes a frequency range with minimum and maximum allowable levels. Specific examples include the United States operating within a frequency range of 902-928 MHz, France operating within 865.6-867.6 MHz, and China operating within 920.5-924.5 MHz. One specific requirement is an Ultra High Frequency (UHF) spectrum regulatory operational requirement for operating the RFID devices 21. Other examples of operational requirements include but are not limited: power levels for operation that include the maximum wattage allowed and calculated as Effective Radiated Power (ERP) or Equivalent Isotropic Radiated Power (EIRP); and reader-tag communication techniques such as Frequency Hopping Spread Spectrum (FHSS), Listen Before Talk (LBT), and European Telecommunications Standards (ETSI).

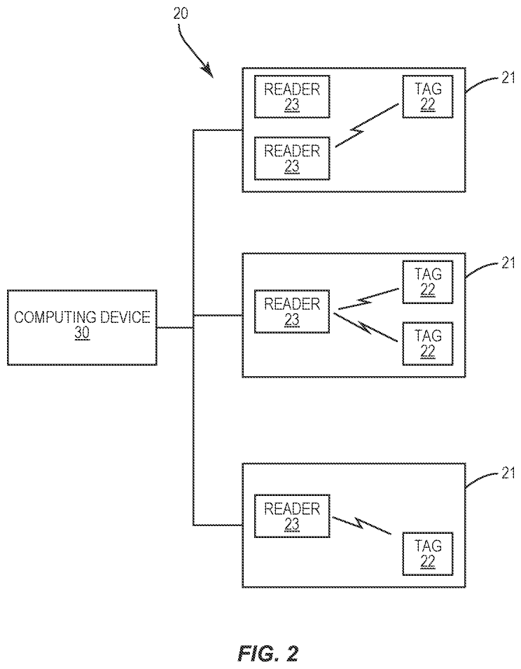

FIG. 2 schematically illustrates an RFID system 20 that is operatively connected to a computing device 30. The connection can be in various manners, such as but not limited to a wireless network or through wired connections. The RFID system 20 is a passive system and includes one or more RFID devices 21 with tags 22 and readers 23. The tags 22 are configured to be attached to an object that is to be tracked/monitored. The readers 23 have antennas that emit an electromagnetic interrogation pulse. In response, the tags 22 transmit digital data, such as an identification number or object information back to the reader 23. In some examples, the collected information is transmitted to the computing device 30 that processes the information. In other examples, the information is transmitted to a different system for processing.

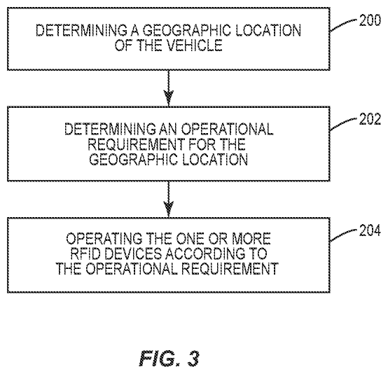

The computing device 30 is configured to determine the geographic location of the vehicle 100 and to operate the RFID system 20 in accordance with the one or more operational requirements for the geographic location. FIG. 3 illustrates a flowchart of the operation of the computing device 30. The computing device 30 determines the geographic location of the vehicle 100 (block 200). This can occur upon the vehicle 100 experiencing an event such as but not limited to an arrival, departure, powering on, and taxiing. The computing device 30 determines an operational requirement for the one or more RFID devices 21 for the geographic location (block 202). The computing device 30 then operates the one or more RFID devices 21 according to the operational requirement (block 204).

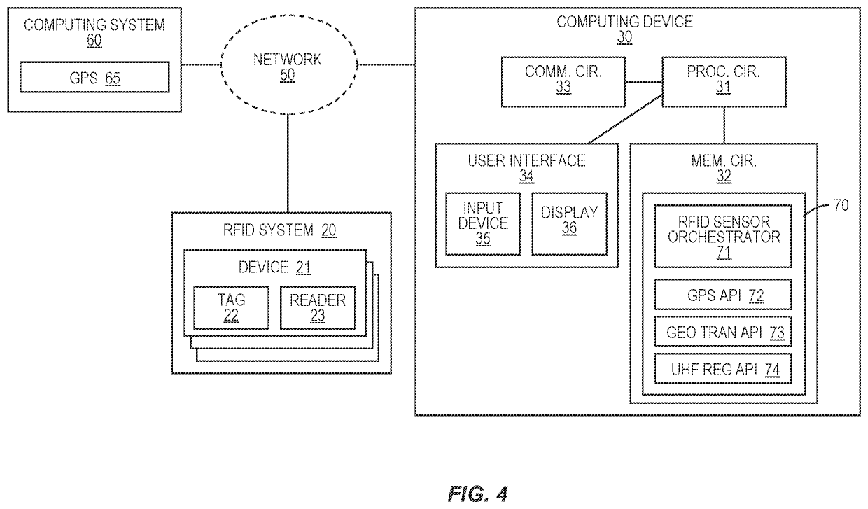

FIG. 4 illustrates a computing device 30 that operates the RFID system 20. The computing device 30 includes processing circuitry 31 that controls the operation of the RFID system 20 according to program instructions 70 stored in memory circuitry 32. The processing circuitry 31 includes one or more circuits, microcontrollers, microprocessors, hardware, or a combination thereof. Memory circuitry 32 includes a non-transitory computer readable storage medium storing the program instructions 70 that configures the processing circuitry 31 to implement one or more of the techniques discussed herein. Memory circuitry 32 can include various memory devices such as, for example, read-only memory, and flash memory. Memory circuitry 32 can be a separate component as illustrated in FIG. 4 or can be incorporated with the processing circuitry 31.

The programming instructions 70 include an RFID sensor orchestrator 71 that provides for configuring the RFID system 20 including the one or more RFID devices 21 to operate in accordance with the applicable geographic requirements. The programming instructions 70 further include one or more application programming interfaces (APIs) that are software modules that are executable to facilitate the exchange of data files between one or more of the computing device 30, the a computing system 60, and the RFID system 20. In one example as illustrated in FIG. 4, the programming instructions 70 includes a GPS API 72, a Geolocation Translation API 73, and a UHF Regulation API 74.

Communication circuitry 33 provides for communications with the computing system 60 located onboard the vehicle 100 and/or remotely away from the vehicle 100. The communication circuitry 33 also provides for communicating with the RFID system 20. In some examples, the communication is through a network 50 located on the vehicle 100. The network 50 comprises a medium configured to provide communication links between various devices and systems. The network 50 can include connections such as wired or wireless communications links, fiber optic cables, and/or any other suitable medium for transmitting and/or communicating data between devices and/or systems.

In some examples, the communication circuitry 33 includes a WLAN interface configured to communicate with a local area network 50, e.g., via a wireless access point. An exemplary WLAN interface operates according to the 802.11 family of standards, which is commonly known as a WiFi interface. In some examples, the communication circuitry 33 includes a personal area network interface, such as a Bluetooth interface. In some examples, the communication circuitry 33 includes a cellular interface that enables communication with a mobile communication network (e.g., a WCDMA, LTE, or WiMAX network).

A user interface 34 provides for a person such as flight personnel, a technician, or other to control one or more aspects of the computing device 30. The user interface 34 includes one or more input devices 35 such as but not limited to a keypad, touchpad, roller ball, and joystick that provide for entering commands to the processing circuitry 31. The user interface 34 can also include one or more displays 36 for displaying information.

The computing device 30 communicates with the computing system 60 on the vehicle 100. The computing system 60 can include a single system that controls one or more functions of the vehicle 100, or two or more separate systems that are interconnected through the network 50. Examples of systems 60 include but are not limited to a flight control system, a flight control surface system, a navigation system, an engine system, an autopilot system, a collision avoidance system, and a weather radar system.

FIG. 4 includes an example in which the computing system 60 includes navigational functionality. The computing system 60 monitors the geographic location of the vehicle 100. In some examples, the navigation computing system 60 includes a global positioning system (GPS) unit 65 that includes a transmitter that communicates with one or more satellites and ground stations that measure the latitude and longitude. The GPS unit 65 further includes a receiver that receives the location information.

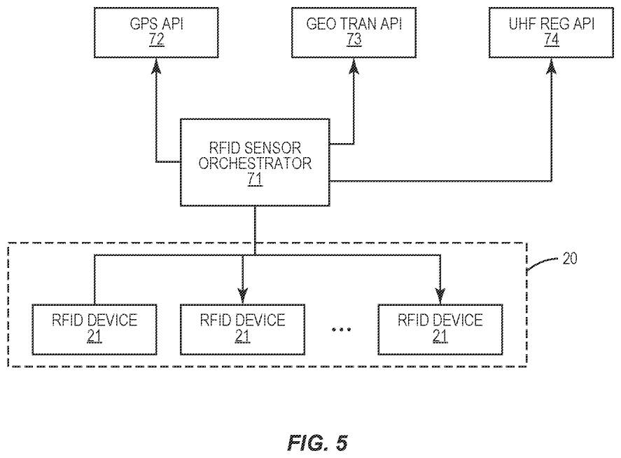

FIG. 5 illustrates the functioning of the computing device 30 to operate the RFID devices 21 of the RFID system 20 in compliance with the applicable geographic requirements. The computing device 30 operates according to instructions of the RFID Sensor Orchestrator 71. The RFID Sensor Orchestrator 71 issues a read command for the geographic location of the vehicle 100. This request can occur in response to an event by the vehicle 100, such as but not limited to an arrival (e.g., landing), departure, taxiing, and power on of a part or entirety of the computing system 60 on the vehicle 100. In other examples, this occurs on a periodic basis such but not limited to hourly, every six hours, and at the same one or more times each day (e.g., noon, midnight). The GPS API 72 returns the geographic location from the GPS unit 65 of the computing system 60. In some examples, the reply from the GPS API 72 is a floating point value pair that represents the current latitude and longitude readings.

Upon receiving the GPS data, the RFID sensor orchestrator 71 polls the Geolocation Translation API 73 for the code that corresponds to the current geographic location. The polling includes providing the geographic location data obtained from the GPS API 72. In return, the Geolocation Translation API 73 provides the code corresponding to the provided GPS data. The code includes one or more of a country code, a city code, a state code, and a region code. In some examples, the Geolocation Translation API 73 returns one or more alpha-2, alpha-3, or numeric country codes.

The RFID sensor orchestrator 71 then queries the UHF Regulation API 74 with the one or more codes. The UHF Regulation API 74 returns the one or more operational requirements for operating the RFID system 20 that correspond to the one or more condes. In some examples, an operational requirement includes a frequency range that includes minimum and maximum allowable levels. Other examples of operational requirements include but are not limited: power levels for operation that include the maximum wattage allowed and reader-tag communication techniques.

The RFID sensor orchestrator 71 determines whether the RFID system 20 is operating in accordance with the one or more operational requirements. The settings on the RFID devices 21 are adjusted as necessary to operate within the requirements for the identified country.

In some examples, the RFID sensor orchestrator 71 polls the RFID devices 21 for the one or more current operational settings (e.g., current frequency band). The current operational settings (e.g., frequency band) for the readers 23 are stored in an RFID reader map data structure. The map data structure is then reviewed and compared to the operational requirements returned from the UHF Regulation API 74. The RFID devices 21 that are within compliance are maintained. Those that are out of compliance are adjusted as necessary. In some examples, for each RFID device 21 that is determined to be in an incompatible operational setting, a Change command (e.g., Frequency_Change command) is sent to the corresponding RFID Device 21.

The process of determining the geographical location, the country code, the operational requirements, as well as determining the frequency settings of the RFID devices 21 and making changes as necessary are saved in an event logging system maintained in the flight system. This log can be used for various reasons, such as for maintenance, operational compliance, inspections, etc.

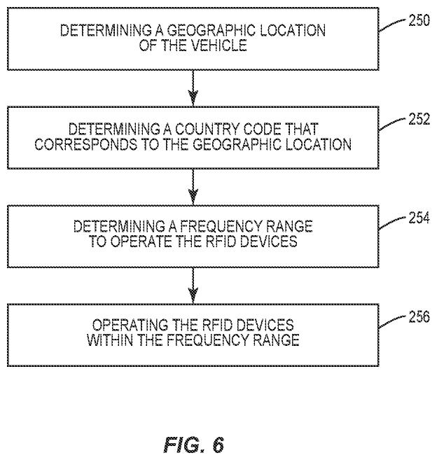

FIG. 6 illustrates a method of operating RFID devices 21 on a vehicle 100. The method determines a geographic location of the vehicle 100 (block 250). A country code is then determined that corresponds to the geographic location (block 252). A frequency range of operation of the RFID devices 21 is determined that corresponds to the country code (block 254). The RFID devices 21 are operated within the frequency range while the vehicle 100 is at the geographic location (block 256).

In some examples, the computing device 30 obtains information from an on-board source for the operation of the RFID devices 21. In other examples, the computing device 30 obtains the information from a remote source that is not on the vehicle 100. For example, the computing device 30 communicates with a remote node of an owner of the vehicle 100 that maintains the various operational requirements. In some examples, the computing device 30 communicates with a governmental authority for the one or more operational requirements.

The computing system 60 and the RFID system 20 include processing circuitry, memory circuitry, and communication circuitry to perform the functions and communicate with the computing device 30. In some examples, the systems are microprocessor-based such as a computer having at least one processor, memory (RAM and/or ROM), and associated input and output buses. In some examples, the processor operates under the control of an operating system that resides in memory. In some examples, the operating system manages computer resources so that computer program code embodied as one or more computer software applications, such as an application residing in memory, includes instructions executed by the processor. In some examples, the processor executes the application directly, in which case the operating system may be omitted.

In some examples, the program instructions 70 are stored in the memory circuitry 32. In other examples, the program instructions 70 are located in a functional form on computer-readable media that is selectively removable and may be loaded onto or transferred to the computing device 30 for execution by the processing circuitry 31. In some examples, the program instructions 70 include computer-readable storage media or computer-readable signal media. Computer-readable storage media may include, for example, an optical or magnetic disk that is inserted or placed into a drive or other device that is part of memory circuitry 32. Computer-readable storage media also may take the form of a persistent storage, such as a hard drive, a thumb drive, or a flash memory, that is connected to the computing device. In some examples, computer-readable storage media is a non-transitory, physical or tangible storage device used to store program instructions.

In some examples, the program instructions 70 are transferred to the computing device 30. e.g., remotely over a network, using computer-readable signal media. Computer-readable signal media may be, for example, a propagated data signal containing the program instructions 70. In some examples, the computer-readable signal media is an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples. In some examples, program instructions 70 are downloaded over a network from another device or data processing system through computer-readable signal media for use within the computing device 30.

In some examples, the program instructions 70 include an operating system (OS). The OS is stored in memory circuitry 32 and controls and allocates resources of the computing device 30. The OS includes any suitable software system configured to manage and expose hardware resources of the computing device 30. In some examples, OS provides APIs that facilitate connection of different type of hardware and/or provide applications access to hardware and OS services. In some examples, certain applications may provide further services for use by other applications, e.g., as is the case with so-called “middleware.”

The methods disclosed can be used on a variety of vehicles 100. Vehicles 100 include but are not limited to manned aircraft, unmanned aircraft, manned spacecraft, unmanned spacecraft, manned rotorcraft, unmanned rotorcraft, satellites, rockets, missiles, manned terrestrial vehicles, unmanned terrestrial vehicles, manned surface water borne vehicles, unmanned surface water borne vehicles, manned sub-surface water borne vehicles, unmanned sub-surface water borne vehicles, and combinations thereof.

The present disclosure can be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of operating radio frequency identification (RFID) devices on a vehicle, the method comprising:
determining a geographic location of the vehicle;
based on the geographic location of the vehicle, determining an operational requirement for the RFID devices; and
operating the RFID devices according to the operational requirement.

2. The method of claim 1, further comprising adjusting a setting on the RFID devices resulting in the RFID devices operating according to the operational requirement.

3. The method of claim 1, further comprising determining the geographic location of the vehicle upon arrival of the vehicle at a destination.

4. The method of claim 1, wherein determining the geographic location of the vehicle comprises determining latitude and longitude of the vehicle and determining a country code corresponding to the latitude and longitude.

5. The method of claim 1, further comprising:
determining a current frequency setting for the RFID devices;
determining that the current frequency setting for the RFID devices is outside of a frequency range; and
adjusting the RFID devices to operate within the frequency range.

6. The method of claim 1, wherein determining the operational requirement for the RFID devices comprises determining a power level of the RFID devices.

7. The method of claim 1, further comprising determining the geographic location and the operational requirement from one or more sources that are located on the vehicle.

8. The method of claim 1, wherein determining the operation requirement comprises determining a UHF spectrum regulatory operational requirement for operating the RFID devices within a country where the vehicle is located.

9. A method of operating radio frequency identification (RFID) devices on a vehicle, the method comprising:
determining a geographic location of the vehicle;
determining a country code that corresponds to the geographic location;
determining a frequency range of operation of the RFID devices that corresponds to the country code; and
operating the RFID devices within the frequency range while the vehicle is at the geographic location.

10. The method of claim 9, further comprising polling an onboard computing system that is on the vehicle and determining one or more of the geographic location, the country code, and the frequency range.

11. The method of claim 9, further comprising determining that an event has occurred with the vehicle and determining the geographic location after occurrence of the event.

12. The method of claim 9, wherein determining the country code comprises determining an alpha-3 country code that corresponds to the geographic location.

13. The method of claim 9, further comprising:
determining a current frequency for the RFID devices;
determining whether the current frequency is within the frequency range;
adjusting a setting of the RFID devices in which the current frequency is outside of the frequency range; and
operating the RFID devices within the frequency range.

14. The method of claim 9, wherein determining the frequency range of operation of the RFID devices that corresponds to the country code comprises determining a UHF spectrum regulatory operational requirement for operating the RFID devices within a country where the vehicle is located.

15. A computing device configured to operate RFID devices, the computing device comprising:
memory circuitry that stores program instructions; and
processing circuitry configured to execute the program instructions to cause the computing device to:
determine a geographic location of the vehicle;
determine a code that corresponds to the geographic location;
determine a frequency range of operation for the RFID devices that corresponds to the code; and
operate the RFID devices within the frequency range.

16. The computing device of claim 15, wherein the processing circuitry is configured to configure one or more onboard systems and obtain the geographic location and the code.

17. The computing device of claim 15, wherein the code is a country code that corresponds to a country where the vehicle is located.

18. The computing device of claim 15, wherein the processing circuitry is further configured to transmit commands to adjust an operational feature of the RFID devices to operate within the frequency range.

19. The computing device of claim 15, wherein the processing circuitry is configured to determine that one or more of the RFID devices are operating within the frequency range and to prevent adjustment of the one or more RFID devices.

20. The computing device of claim 15, wherein the code is a city code that corresponds to a city where the vehicle is located.
